(19) United States
(12) Patent Application Publication
(10) Pub. No.: US 2019/0193220 A1
(43) Pub. Date: Jun. 27, 2019

(54) COMBINED THROUGH-HOLE PROCESSING MACHINE

(71) Applicant: KAO FONG MACHINERY CO., LTD., Taichung (TW)

(72) Inventors: SHENG-TUN WU, TAICHUNG (TW); YI-SHEN CHU, TAICHUNG (TW); TSUNG-MING CHEN, TAICHUNG (TW); YI-LANG TSAI, TAICHUNG (TW)

(21) Appl. No.: 15/956,372

(22) Filed: Apr. 18, 2018

(30) Foreign Application Priority Data
Dec. 26, 2017 (TW) 106219235

(51) Int. Cl. B23Q 5/04; B23Q 1/01; B23Q 5/38; B23Q 3/08

(52) U.S. Cl. CPC B23Q 5/043; B23Q 1/015; B23Q 2703/02; B23Q 5/041; B23Q 3/08; B23Q 5/385

(57) ABSTRACT

A combined through-hole processing machine includes a working bed provided with two opposite and parallel slide rails on it. A deep-hole processing mechanism is provided on the working bed and includes a pair of sub-spindle heads used to clamp a deep-hole tool respectively to conduct the deep-hole processing on workpiece. A U axis feed unit is provided between the two slide rails and used to provide the feed for the movement in the long axis direction parallel to the two slide rails. A deburring mechanism is provided on the working bed and located at one end side of the deep-hole processing mechanism, which includes the corresponding two chucks and two tailstocks where the chucks are used to clamp the workpiece with the deep-hole processing already fulfilled on the deep-hole processing mechanism respectively and the tailstocks are provided to arrange the deburring tools respectively to conduct the deep-hole deburring action.

### BACKGROUND OF INVENTION

### 1. Field of the Invention

The present invention relates generally to an item of processing equipment, and more particularly to a kind of combined through-hole processing machine which can fulfill two processes on one processing machine at the same time with no need for cross-machine transport, thus able to significantly shorten working hours and raise the production efficiency.

### 2. Description of Related Art

It is well known that the method of slender shaft part processing is to first fulfill the front-end process of deep hole processing on one processing machine (such as the through-hole processing machine) and then fulfill the deburring processing action on another deburring machine. That is, when the deep-hole processing action on the slender shaft part is fulfilled on the processing machine, the slender shaft part must be taken off the processing machine, transported to the deburring machine location, assembled and clamped again onto the deburring machine and repositioned for hole alignment before the deburring action is conducted finally. It consumes the non-processing time like workpiece assembling and clamping, repositioning for hole alignment and cross-machine transport considerably, which is against the economic benefit and a defect needs to be improved urgently.

In light of the above situation, the inventor has spent lots of time to study the related knowledge and compare the advantages and disadvantages, made the research and development of related products, conducted many experiments and tests, and finally come up with a kind of combined through-hole processing machine to meet the public need in application.

### SUMMARY OF THE INVENTION

The main purpose of the present invention is to provide a kind of combined through-hole processing machine capable of fulfilling two processes on one processing machine at the same time to shorten the time for workpiece disassembling and assembling as well as repositioning for hole alignment without needing to consume the non-processing time like cross-machine transport and therefore able to greatly improve the efficiency of production line.

Thereby, in order to achieve the above purpose and effect, the present invention provides a kind of combined through-hole processing machine, including a working bed, provided with two opposite and parallel slide rails on it; a deep-hole processing mechanism, provided on the working bed and including a pair of sub-spindle heads used to clamp a deep-hole tool respectively to conduct the deep-hole processing on workpiece; a U axis feed unit, provided between the two slide rails used to provide the feed for the movement in the long axis direction parallel to the two slide rails; and a deburring mechanism, provided on the working bed and located at one end side of the deep-hole processing mechanism and including the corresponding two chucks and two tailstocks where the chucks are used to clamp the workpiece with the deep-hole processing already fulfilled on the deep-hole processing mechanism respectively and the tailstocks are provided to arrange the deburring tools respectively to conduct the deep-hole deburring action on the workpiece.

### BRIEF DESCRIPTION OF THE DRAWING

FIG. 1 is schematic diagram of the appearance of a preferred embodiment of the present invention.

FIG. 2 is schematic perspective view of the appearance of a preferred embodiment of the present invention.

FIG. 3 is a part of the cross-section schematic diagram of a preferred embodiment of the present invention.

### DETAILED DESCRIPTION OF THE INVENTION

The further description will be provided in details hereinafter by taking a preferred embodiment of the present invention for example and in combination with the drawings, where

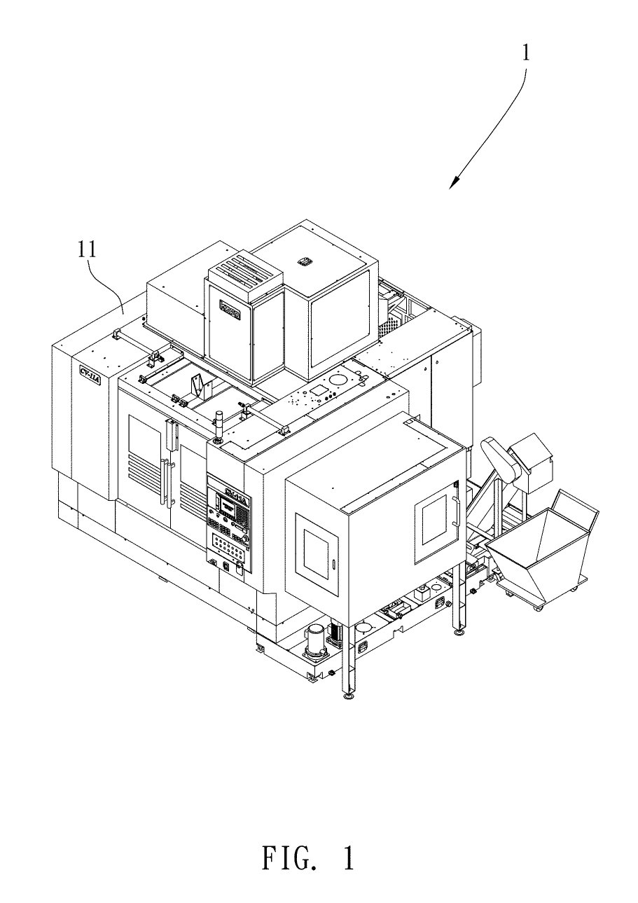

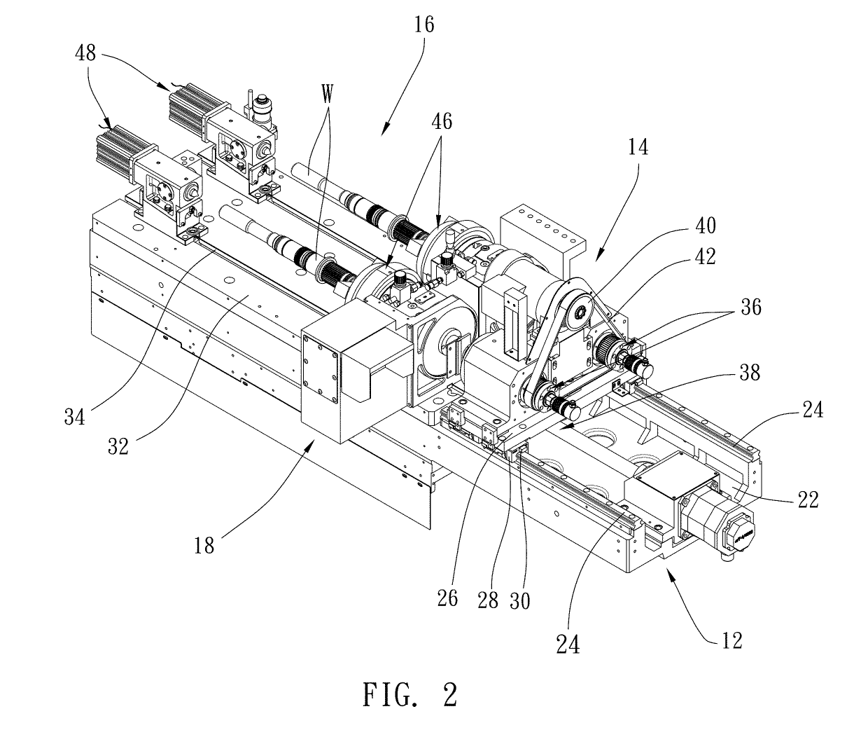

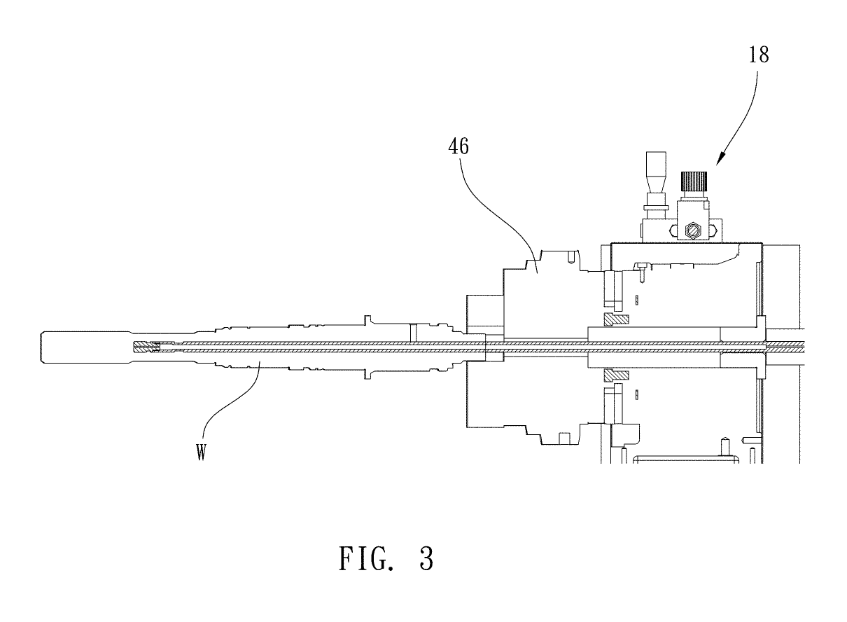

Referring to FIGS. 1 to 3 wherein the combined through-hole processing machine 1 for the through holes of a preferred embodiment of the present invention can provide both the through hole making and deburring (burr) processing actions to the slender shaft workpiece W (such as the automobile transmission shaft) and includes an outer housing 11 a working bed 12 arranged inside the outer housing 11, a deep-hole processing mechanism 14 and a deburring mechanism 16.

The working bed 12 is in a U shape where a concave space 22 is provided at its top side; a slide rail 24 is arranged at the end of the two side walls in the front-end part of the working bed 12 respectively; a base plate 26 is erected by several blocks 28 onto the two slide rails 24 where the slide blocks 28 are provided with the corresponding grooves 30 nested in the two slide rails 24 respectively; and a upper plate 32 is arranged in the rear-end part of the working bed 12, connected with one end of the two slide rails 24 and provided with two grooves 34 extending in the long axis direction and parallel to the two slide rails 24 on it.

The deep-hole processing mechanism 14 includes a pair of sub-spindle heads 36, a U axis feed unit 38 and motor 40, transmission belt 42 and other components. The pair of sub-spindle heads 36 are provided on the base plate 26 used to clamp a deep-hole tool respectively to conduct the deep-hole processing on workpiece. The U axis feed unit 38 is provided in the concave space 22 between the two slide rails used to provide the feed for the movement in the long axis direction parallel to the two slide rails 24. Since the components like the pair of sub-spindle heads 36, motor 40, transmission belt 42 and U axis feed unit 38 are well known components and not the main feature technologies of the invention, no descriptions of their detailed structures will be provided herein.

The deburring mechanism 16 is provided on the working bed 32 and located at one end side of the deep-hole processing mechanism 14 and includes the corresponding two chucks 46 and two tailstocks 48 where the chucks 46 are used to clamp the workpiece W with the deep-hole processing already fulfilled on the deep-hole processing mechanism 14 respectively; the tailstocks 48 are provided to arrange the deburring tools respectively to conduct the deep-hole deburring action on the workpiece W; and the tailstocks 48 are provided on the two grooves 34 used to adjust the position of the tailstocks 48 fixed on the grooves according to the length of the workpiece 2 clamped by the two chucks 46.

The combined through-hole processing machine 1 can even include a well-known processing mechanism 18 in the 4^{th} axial direction to be provided on the upper plate 32 and located between the deep-hole processing mechanism 14 and deburring mechanism 16, which is able to be used to conduct the side-hole through-hole processing action on the workpiece W.

Further, a well-known air blowing mechanism (not shown in drawing) corresponding to the deburring mechanism 16 can even be provided and used to blow off the cuttings after deburring to facilitate the subsequent optical inspection operation of the burrs.

Thereby, the application method, features and the effectiveness of the combined through-hole processing machine 1 of the present invention are as follows:

In the case of deep-hole processing on shaft parts, it can first put the workpiece W on the deep-hole processing mechanism 14 for the deep-hole operation (the processing mechanism 18 in the 4^{th} axial direction can also be used again to conduct the side hole processing), then move the workpiece W to the deburring mechanism 16 and use the chucks 46 to clamp the workpiece W, and then perform the deburring (burr) processing action on the workpiece W. Certainly, when the deburring processing is performed by the deburring mechanism 16, the deep-hole processing mechanism 14 can conduct the deep-hole operation of other workpieces at the same time.

Thus, through the present invention of the combined through-hole processing machine, two processes (through-hole making and deburring) can be fulfilled on one processing machine at the same time, which can shorten the non-processing time like that for workpiece assembling and clamping, repositioning for hole alignment and cross-machine transport and thus greatly improve the efficiency of production line and achieve the intended purpose of invention.

Further, the combined through-hole processing machine 1 of the present invention is of the two-part operation (with the two kinds of processing of through-hole making and deburring carried out at the same time); the well-known stand-alone through-hole processing machine is of the single-part operation; in comparison, the present invention can improve the output efficiency of production line as well. Also, the price of the combined through-hole processing machine of the present invention can be more favorable than the original two equipment (through-hole processing machine and deburring machine), which is more advantageous capital expenditure to customers. It has practical and progressive effect and can better enhance the industrial competitiveness.

What is claimed is:

1. A kind of combined through-hole processing machine, which comprises:
a working bed, provided with two opposite and parallel slide rails on it;
a deep-hole processing mechanism, provided on the working bed and including a pair of sub-spindle heads used to clamp a deep-hole tool respectively to conduct the deep-hole processing on workpiece; a U axis feed unit, provided between the two slide rails used to provide the feed for the movement in the long axis direction parallel to the two slide rails; and
a deburring mechanism, provided on the working bed and located at one end side of the deep-hole processing mechanism and including the corresponding two chucks and two tailstocks where the chucks are used to clamp the workpiece with the deep-hole processing already fulfilled on the deep-hole processing mechanism respectively and the tailstocks are provided to arrange the deburring tools respectively to conduct the deep-hole deburring action on the workpiece.

2. The structure defined in claim 1, wherein a processing mechanism in the 4^{th} axial direction can even be included to be provided on the working bed and located between the deep-hole processing mechanism and deburring mechanism, which is able to be used to conduct the side-hole through-hole processing action on the workpiece.

3. The structure defined in claim 1, wherein a concave space is provided on the working bed; the two slide rails are provided at the top edges of the concave space on both sides oppositely; and the U axis feed unit is provided in the concave space.

4. The structure defined in claim 2, wherein a concave space is provided on the working bed; the two slide rails are provided at the top edges of the concave space on both sides oppositely; and the U axis feed unit is provided in the concave space.

5. The structure defined in claim 3, wherein the deep-hole processing mechanism includes a base plate erected on the two slide rails; and the pair of sub-spindle heads are provided on the base plate.

6. The structure defined in claim 4, wherein the deep-hole processing mechanism includes a base plate erected on the two slide rails; and the pair of sub-spindle heads are provided on the base plate.

7. The structure defined in claim 4, wherein the base plate is erected by several blocks onto the two slide rails where the slide blocks are provided with the corresponding grooves nested in the two slide rails respectively.

8. The structure defined in claim 1, wherein an upper plate is even included and erected on the working bed with one end connected with one end of the two slide rails; and the deburring mechanism is provided on the upper plate.

9. The structure defined in claim 2, wherein an upper plate is even included and erected on the working bed with one end connected with one end of the two slide rails; and the deburring mechanism is provided on the upper plate.

10. The structure defined in claim 8, wherein the upper plate is even provided with two grooves extending in the long axis direction and parallel to the two slide rails on it; and the tailstocks are provided on the two grooves used to adjust the position of the tailstocks fixed on the grooves according to the length of the workpiece clamped by the two chucks.

11. The structure defined in claim 9, wherein the upper plate is even provided with two grooves extending in the long axis direction and parallel to the two slide rails on it; and the tailstocks are provided on the two grooves used to adjust the position of the tailstocks fixed on the grooves according to the length of the workpiece clamped by the two chucks.
